(19) United States
(12) Patent Application Publication
(10) Pub. No.: US 2019/0157702 A1
(43) Pub. Date: May 23, 2019

(54) FUEL CELL SECONDARY INTERCONNECT

(71) Applicant: LG Fuel Cell Systems, Inc., North Canton, OH (US)

(72) Inventors: Zhien Liu, Canal Fulton, OH (US); Rich Goettler, Medina, OH (US)

(73) Assignee: LG Fuel Cell Systems, Inc., North Canton, OH (US)

(21) Appl. No.: 15/816,931

(22) Filed: Nov. 17, 2017

(51) Int. Cl. H01M 8/249; H01M 8/1246; H01M 8/2428; H01M 8/0215; H01M 8/0254; H01M 8/021; H01M 8/0208; H01M 8/0217

(52) U.S. Cl. CPC H01M 8/249; H01M 8/1246; H01M 8/2428; H01M 8/0215; H01M 2008/1293; H01M 8/021; H01M 8/0208; H01M 8/0217; H01M 8/0254

(57) ABSTRACT

In accordance with some embodiments of the present disclosure, a fuel cell system is provided. The fuel cell system may comprise a plurality of stacked fuel cell tubes and a secondary interconnect. Each tube may comprise a substrate, a plurality of fuel cells, a first sheet conductor, and a second sheet conductor. The substrate may have a pair of opposing major surfaces and define a plurality of parallel channels between the major surfaces extending from a first end to a second end of said tube. The plurality of fuel cells may be disposed on one of said major surfaces, the fuel cells being electrically coupled in series to one another. The first sheet conductor may be located proximate the first end of the tube, the first sheet conductor providing an electrical path from a location on one of the major surfaces to a location on the other of the major surfaces. The second sheet conductor may be located proximate the second end of the tube, the second sheet conductor providing an electrical path from a location on one of the major surfaces to a location on the other of the major surfaces. The secondary interconnect may electrically couple the first sheet conductors on adjacent fuel cell tubes thereby electrically coupling the fuel cells disposed on one fuel cell tube to the fuel cells disposed on an adjacent fuel cell tube.

### RELATED APPLICATIONS

This application is related to concurrently filed and co-pending U.S. application Ser. No. ______, filed Nov. 17, 2017, entitled “Multiple Fuel Cell Secondary Interconnect Bonding Pads and Wires,” bearing Docket Number G3541-00244/FCA12024, with named inventors Gerry Agnew, U.S. application Ser. No. ______, filed Nov. 17, 2017, entitled “Fuel Cell Ink Trace Interconnect,” bearing Docket Number G3541-00245/FCA12023, with named inventors Ed Daum, U.S. application Ser. No. ______, filed Nov. 17, 2017, entitled “Improved Fuel Cell Secondary Interconnect,” bearing Docket Number G3541-00181/FCAG11711, with named inventors Zhien Liu, Rich Goettler, Ed Daum, and Charles, Osborn, and U.S. application Ser. No. ______, filed Nov. 17, 2017, entitled “Secondary Interconnect for Fuel Cell System,” bearing Docket Number G3541-00215/FCAG11484 (11711), with named inventors Zhien Liu, Rich Goettler, Gerry Agnew, and Peter Dixon, the entirety of all these applications is incorporated herein by reference.

### STATEMENT REGARDING FEDERALLY SPONSORED RESEARCH OR DEVELOPMENT

This invention was made with Government support under Assistance Agreement No. DE-FE0023337 awarded by Department of Energy. The Government has certain rights in this invention.

### TECHNICAL FIELD

The disclosure generally relates to fuel cells. More specifically, this disclosure relates to systems and method for connecting groups of fuel cells.

### BACKGROUND

A fuel cell is a device that can convert fuel (e.g., hydrogen) and oxidant (e.g., oxygen) in an electrochemical reaction that releases electrons and produces reaction products (e.g., water). While the specific voltage generated by a fuel cell depends on the composition of the fuel used in the electrochemical fuel cell reaction, most fuel cells can generate about 1 volt of electric potential at an amperage that is dependent of the surface areas of the fuel cell electrodes, assuming a sufficient supply of fuel and oxidant is provided. The resultant electrical power produced by a fuel cell, which is also dependent on the fuel cell electrode surface area, and can range from several hundred milliwatts to several hundred watts.

To provide the electrical voltage, current and power demanded by many electrical loads, fuel cell systems designs typically comprise a plurality of electrically connected individual fuel cells. Fuel cell systems often electrically connect several individual fuel cells together in groups to raise the electric potential across the several cells, the current supplied by the group at a particular voltage, or some combination of both voltage and current. The electrical connections provided between individual fuel cells (specifically from the anode of one fuel cell to the cathode of another cell) may be referred to as “primary interconnects.” The higher-voltage groups of fuel cells may then be connected to other higher-voltage groups in parallel or series to provide more power output. The electrical connections between these groups of fuel cells may be referred to as “secondary interconnects.”

Systems and methods for connecting fuel cells with secondary interconnects remain an area of interest. Some existing systems have various shortcomings, drawbacks, and disadvantages. Accordingly, there remains a need for further contributions in this area of technology.

### SUMMARY

While many fuel cell systems connect individual fuel cells to one another in a manner resembling that described above, there exist many different designs for fuel cell systems comprising a plurality of fuel cells having primary interconnects. One such design is the integrated planar solid-oxide fuel cell (SOFC), also known as a segmented-in-series SOFC. An example of an integrated planar SOFC system 100 deposited on fuel cell tube 130 is illustrated in FIGS. 1A and 1B. In this design, all active layers (e.g., anode 112, electrolyte 110, and cathode 108) of a fuel cell 140, and the primary interconnects 116 may be deposited on an inert porous ceramic substrate 120. The fuel cells 140 of system 100 may further comprise cathode current collector (CCC) 106 and anode current collector (ACC) 114. Primary interconnects 116 are disposed between and electrically connect adjacent fuel cells 140. The interconnects 116 may be in electrical contact with the ACC 114 of one cell and the CCC 106 of an adjacent cell, thereby connecting the adjacent cells 140 in series.

Substrate 120 is often shaped as a tube that may define internal passages (or channels) 142, which may be parallel to one another, for the flow of fuel, oxidant, or both. A plurality of individual fuel cells 140 may be deposited on one surface of the substrate 120. The porous substrate tube 120 may be circular or flat, comprising a pair of generally planar, parallel surfaces. Substrate 120 may be a flat tube, as shown in FIG. 1B, having a first end 144 and second end 146, first edge 148 and second edge 150, and a pair of opposing surface 152 (top) and 154 (bottom) extending between the first and second ends 144 and 146 and the first and second edges 148 and 150. If the substrate 120 is a flat tube, fuel cells 140 may be deposited on the other side (e.g., 154 (bottom side)) of the substrate 120. The fuel cells 140 on any one side of the tube 120 may be connected to the other cells 140 on the same side by primary interconnects 116 (not shown in FIG. 1B).

A plurality of fuel cells 140 on one side of a tube 130 may also be electrically connected in series or parallel to another fuel cell 140 or plurality of fuel cells 140 on another side of the same tube 130 by secondary interconnects wires 102. The secondary interconnects (SICs) 102 and 104 may be disposed proximate to the distal ends 144 and 146, respectively, of the tube 130 and may be electrically coupled with the ACC 114 and CCC 106 of the cells 140 proximate to the distal ends 144 and 146 of the tube 130, respectively. The SICs 102 and 104 may be a metal wire that electrically connects the plurality of fuel cells 140 on the top surface 152 and bottom surface 154 together in parallel, although other electrical connections are possible. As shown in FIG. 1B, the multiple SICs 102, 104 or both may be located at the tube 130 ends 144 and 146 at one or both sides 148 and 150 of tube 130.

Additionally, these connected pluralities of fuel cells 140 on one tube 130 may be connected to additional pluralities of fuel cells 140 on adjacent tubes 130 by additional secondary interconnects. FIG. 2 illustrates an elevation view of one end 244 of a plurality of electrically fuel cell tubes 230 arranged in a bundle 200. A plurality of SICs 202 electrically couple the individual fuel cells (not shown), that may be similar to the fuel cell 140 described above, in the bundle 200. As shown, wire 202a is coupled to a fuel cell on one side of a fuel cell tube 230a and wire 202b is coupled to a fuel cell on the other side the same fuel cell tube 230a. SICs 202a and 202b may then be electrically coupled to one another, such as, e.g., bonding by spot welding or other technique to electrically couple the fuel cells on the top and bottom surfaces (252 and 254) of tube 230a. Similarly, wire 202c is coupled to a fuel cell on one side of an adjacent fuel cell tube 230b, and wire 202d is coupled to a fuel cell on the other side of the same adjacent fuel cell tube 230b. SICs 202c and 202d may then be electrically coupled to one another, such as, e.g., bonding by spot welding or other technique to electrically couple the fuel cells on the top and bottom surfaces of tube 230b. These four SIC wires 202a, 202b, 202c, and 202d may then be bonded, such as, e.g. spot welded, to one another at point 232 in order to electrically couple the pluralities of fuel cells on adjacent fuel cell tubes 230a and 230b in series with one another. Additionally, the fuel cells on one side of any fuel cell tube 230 may be electrically coupled in parallel with the fuel cells on the other side of the same tube 230.

While the fuel cell tubes 230 in FIG. 2 are described as being connected in series and fuel cells on one side of the tube are in parallel with the cells on the other side of the same tube, the inter- and intra-tube electrical connections may be altered to provide other connection designs.

A plurality of bundles 200 may be electrically connected to form a strip, and multiple strips can form a block to generate higher voltages and electrical power.

SICs of this design present challenges which can hamper the performance of a fuel cell system. For example, the gap 256 between SIC wires 202 is difficult to control in this design. This gap 256 may be reduced during the handling and assembly of the system, and this reduction may occur at one end of a pair of cell tubes, such, e.g., between 230c and 230d in FIG. 2, that are not electrically coupled at that end. Additionally, fuel cell operations may cause SIC wire 202 movement due to material aging and creep at high temperatures. Smaller SIC wire gaps 256 may result in arcing or short circuits during operation. Severe arcing or short circuits may result in higher local currents, leading to fuel starvation. In turn, fuel starvation may convert the operating mode of the effected cells leading to oxygen pumping (i.e., generating oxygen) that can cause local burning. The high local temperatures caused by the arcing, short circuits, local burning, or any of these may generate crakes in the porous substrates of the tubes and cause failures in the fuel cell system.

As described herein, systems and methods for intra- and inter-fuel cell tube electrical connections are disclosed that provide more robust and reliable fuel cell system designs by addressing the aforementioned short comings of previous systems and methods.

In accordance with some embodiments of the present disclosure, a fuel cell system is provided. The fuel cell system may comprise a plurality of stacked fuel cell tubes and a secondary interconnect. Each tube may comprise a substrate, a plurality of fuel cells, a first sheet conductor, and a second sheet conductor. The substrate may have a pair of opposing major surfaces and define a plurality of parallel channels between the major surfaces extending from a first end to a second end of said tube. The plurality of fuel cells may be disposed on one of said major surfaces, the fuel cells being electrically coupled in series to one another. The first sheet conductor may be located proximate the first end of the tube, the first sheet conductor providing an electrical path from a location on one of the major surfaces to a location on the other of the major surfaces. The second sheet conductor may be located proximate the second end of the tube, the second sheet conductor providing an electrical path from a location on one of the major surfaces to a location on the other of the major surfaces. The secondary interconnect may electrically couple the first sheet conductors on adjacent fuel cell tubes thereby electrically coupling the fuel cells disposed on one fuel cell tube to the fuel cells disposed on an adjacent fuel cell tube.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

The description herein makes reference to the accompanying drawings wherein like reference numerals refer to like parts throughout the several views.

FIGS. 1A and 1B illustrate a fuel cell system having a fuel cell tube.

FIG. 2 illustrates a fuel cell system having a bundle of fuel cell tubes and a plurality of secondary interconnects.

FIG. 3 illustrates a side view of a fuel cell tube in accordance with some embodiments of the present disclosure.

FIG. 4A-4B illustrate end views of the fuel cell tube of FIG. 3 in accordance with some embodiments of the present disclosure.

FIG. 5 illustrates an alternate end view of the fuel cell tube of FIG. 3 in accordance with some embodiments of the present disclosure.

FIG. 6 illustrate a perspective view of a fuel cell tube in accordance with some embodiments of the present disclosure.

FIG. 7A-7B illustrate fuel cell systems having a bundle of fuel cell tubes and a plurality of secondary interconnects in accordance with some embodiments of the present disclosure.

FIG. 8 illustrates a cross section view of fuel cell tubes shown in FIG. 7A in accordance with some embodiments of the present disclosure.

FIG. 9A-9D illustrates SIC connecting members in accordance with some embodiments of the present disclosure.

FIG. 10 illustrates a SIC connecting member in accordance with some embodiments of the present disclosure.

FIG. 11 is a plot of the fuel cell ASR vs. temperature at various points in time for the fuel cell system in accordance with some embodiments of the present disclosure.

FIG. 12 is a plot of the fuel cell ASR and temperature vs. time for the fuel cell system in accordance with some embodiments of the present disclosure.

Referring to the drawings, some aspects of a non-limiting examples of a fuel cell system in accordance with an embodiment of the present disclosure are schematically depicted. In the drawing, various features, components and interrelationships therebetween of aspects of embodiment of the present disclosure are depicted. However, the present disclosure is not limited to the particular embodiments presented and the components, features and interrelationships therebetween as are illustrated in the drawings and described herein.

### DETAILED DESCRIPTION

In accordance with some aspects of the disclosure, fuel cell tubes having fuel cells that are electrically coupled to fuel cells on other fuel cell tubes, or on different sides of the same tube using SICs are provided. These fuel cell tubes may utilize conductive ink traces and sheet conductors to provide electrical pathways from the fuel cells on one side of a fuel cell tube to the fuel cells on the other side of the same fuel cell tube. A SIC may provide an electrical pathway from the sheet conductor of one fuel cell tube to the sheet conductor of an adjacent fuel cell tube. In this manner, the number of SIC wires used to electrically couple fuel cells is reduced or eliminated. Importantly, the elimination of SIC wires that are disposed between adjacent fuel cell tubes at one end of the tube but that are not intended to provide an electrical pathway between the two adjacent tubes are eliminated, significantly reducing the risk of arcing and short circuits, movement of SIC wires during manufacturing, handling, and testing and operation, and provides easier manufacturing and installation. This new design provides for a more robust fuel cell system.

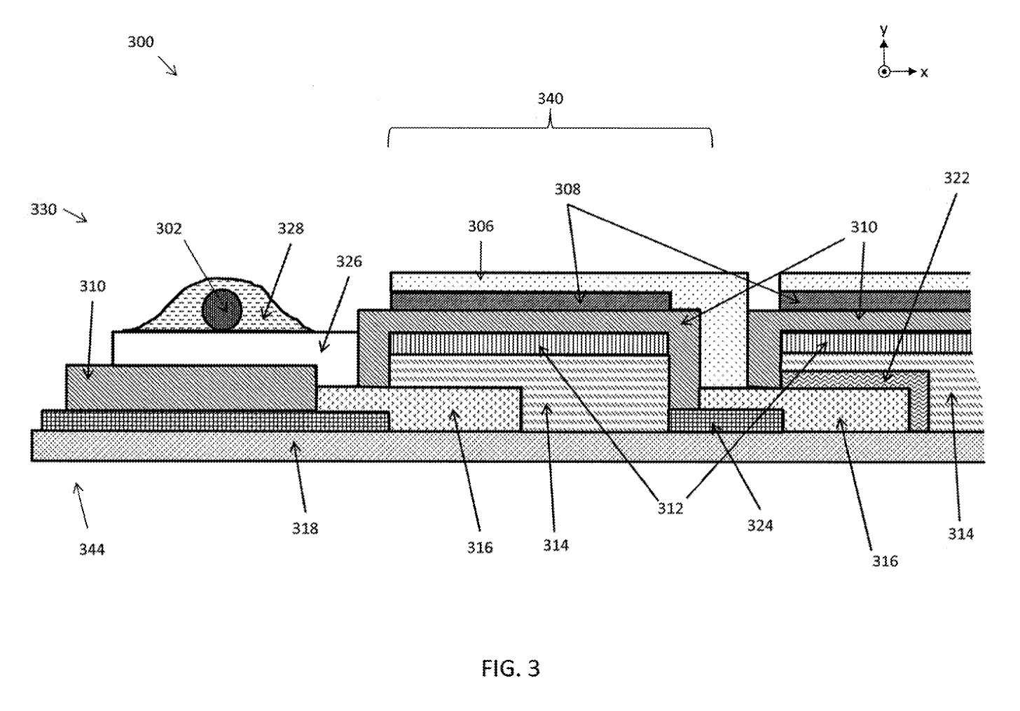

In accordance with some embodiments of the present disclosure, a fuel cell system 300 having a fuel cell tube 330 having fuel cells 340 electrically coupled to an SIC wire 302 is provided in FIG. 3. FIG. 3 illustrates a portion of a fuel cell tube 330 near a first end 344 of that tube 330. Fuel cell tube 330 comprises a plurality of fuel cells 340, each comprising a CCC 306, cathode 308, electrolyte 310, anode 312, ACC 314, interconnects 316, PAB 318 and porous substrate (not shown), each of which components may be as described above. One or more of the fuel cells 340 of tube 330 may further comprise a chemical barrier 322, dense barrier 324 (which may be a ceramic seal), or both. SIC 302 may be electrically coupled to the anode 312 of a fuel cell, e.g., the furthest left fuel cell 340 of FIG. 3, by ACC 314, interconnect 316 (also known as a primary interconnect), and conductor 326. Additionally, a conductive paste 328 may be used to increase the area of electrical contact between conductor 326 and SIC 302 and provide a means to secure SIC 302 to conductor 326. SIC 302 may then be bonded, such as, e.g., spot welded, to additional SICs (not shown) to electrically couple fuel cells on other fuel cell tubes 330.

Conductor 326 may electrically couple the SIC wire 302 to the primary interconnect 316. In some embodiments, conductor 326 may comprise the same material as CCC 306. In some embodiments, conductor 326 may be referred to as a SIC layer and be comprised of the same or similar materials and have a similar design to, e.g., the SIC (e.g., layer 40) as described in the concurrently filed U.S. patent application Ser. Nos. ______, and ______. In some embodiments, conductor 326 may comprise multiple layers, with one layer comprising material from which CCC 306 is composed and another layer comprising a different material, e.g., that from which SIC (e.g., layer 40 or 458 described below) is composed.

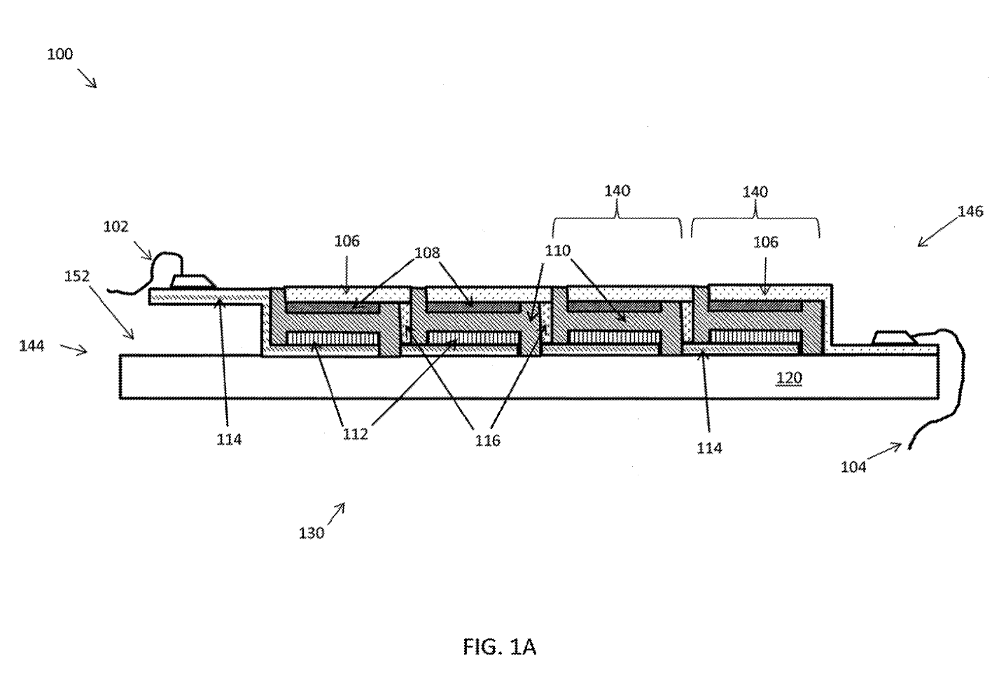

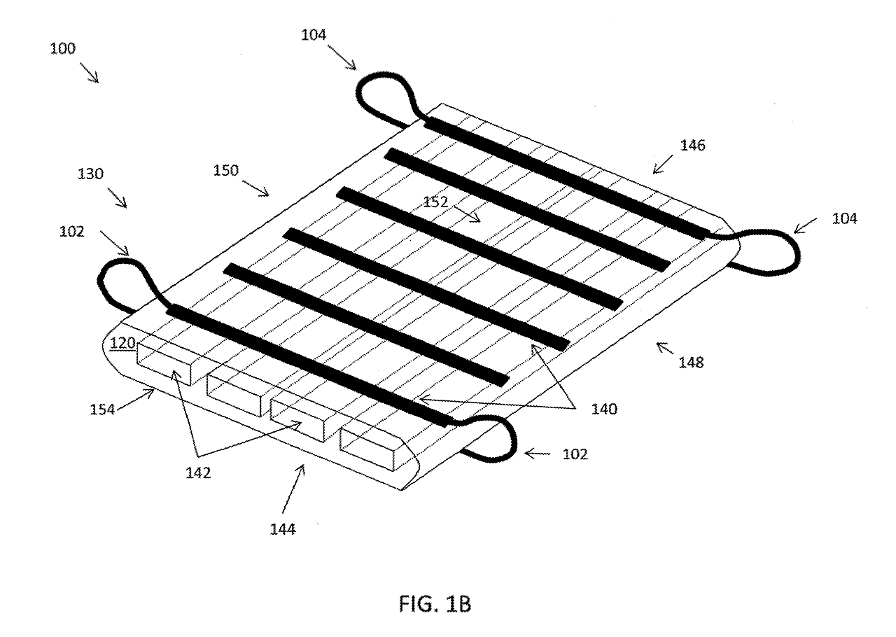

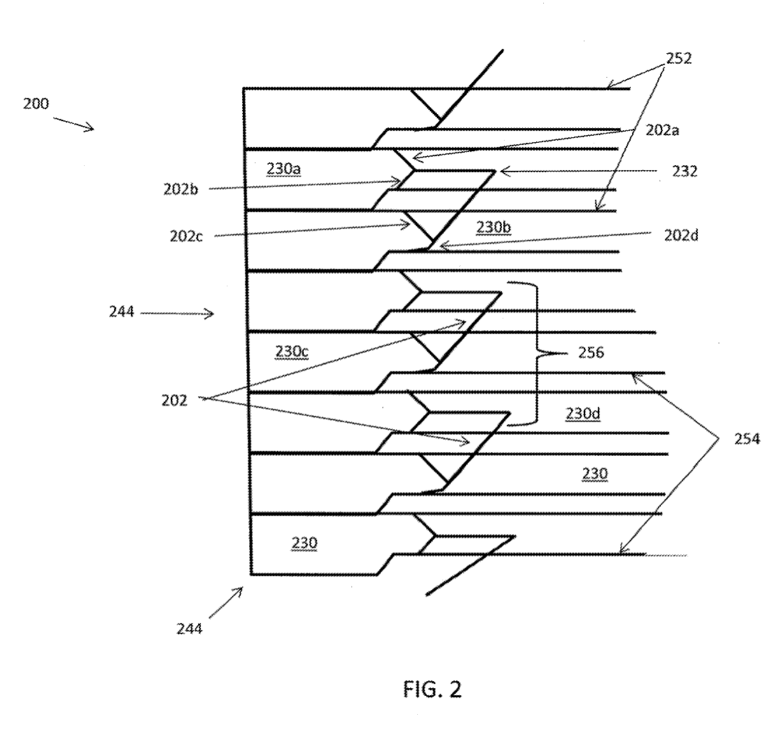

While not shown in FIG. 3, the fuel cell system 300 may further comprise a sheet conductor, e.g., sheet conductor 434 described below, that may function to provide an electrical path from a location on one of the major surfaces of the fuel cell tube 330, e.g., top surface 152 as shown in FIG. 1B, to a location of another major surface of the fuel cell tube, e.g., the bottom surface 154. The sheet conductor may be located between the conductor 326 and the SIC wire 402 and bonding past 328 or embodiments without conductor 326.

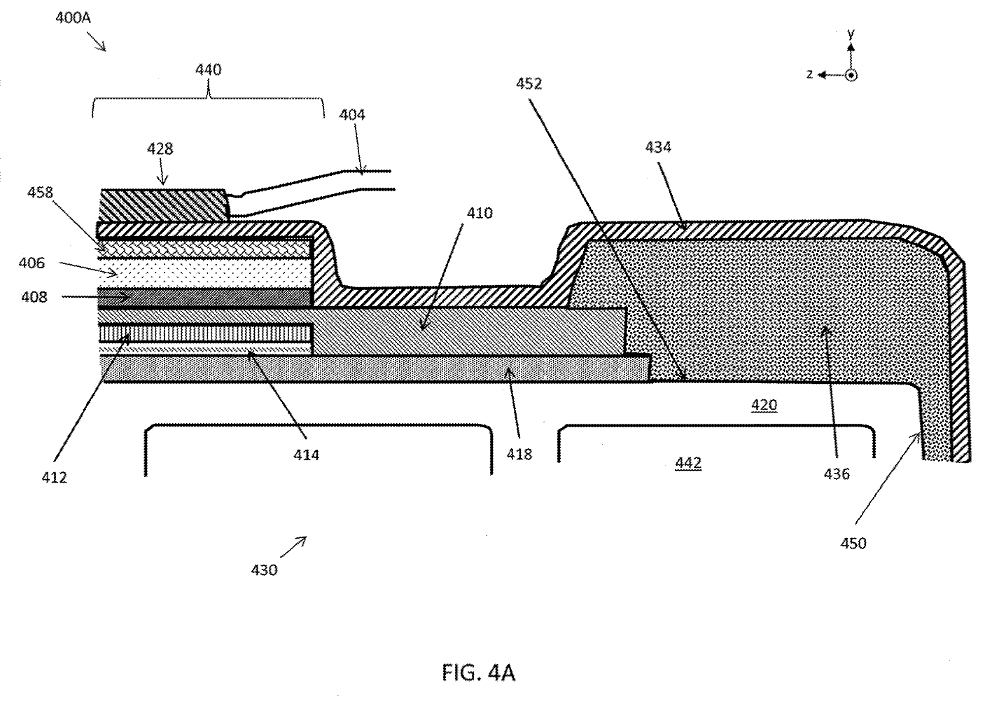

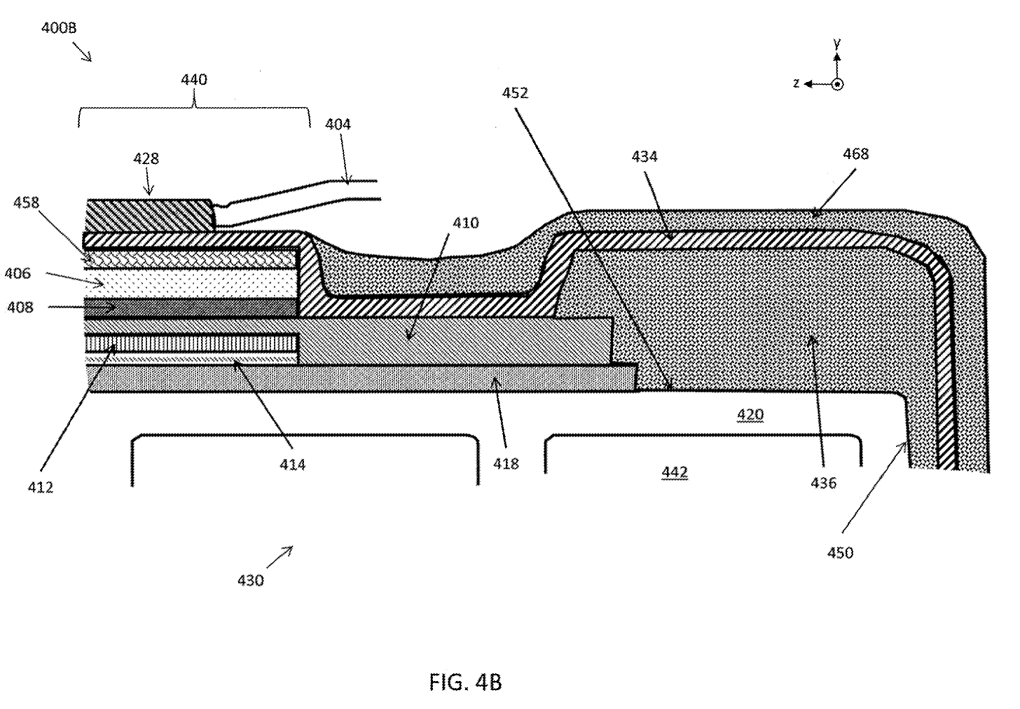

In accordance with some embodiments of the present disclosure, an end-view of a fuel cell system 400A and 400B showing a part of a fuel cell tube 430 is provided in FIGS. 4A-4B. The fuel cell tube 430 may comprise a CCC 406, cathode 408, electrolyte 410, anode 412, ACC 414, PAB 418, SIC layer 458, SIC wire 404, bonding or conductive past 428 and porous substrate 420 and additional components not shown such as a primary interconnect, chemical barrier, dense barrier, and ceramic seal. Each of these components may be as described in the above embodiments.

The fuel cell system 400A may further comprise a sheet conductor 434 and a sealing material 436. The sheet conductor 434 may comprise the materials specific in related the concurrently filed U.S. patent application. Nos. ______, and ______. Sheet conductor 434 may contact SIC layer 458 at a location proximate to an edge of the SIC layer 458 that is closest to tube edge 450 and at some location that is a distance from the edge 450 that is greater than the distance between the SIC layer 458 and edge 450. This arrangement allows the sheet conductor 434 to overlap the SIC layer 458 by some amount and be electrically coupled thereto. The extent of the overlap and the area of contact between the SIC layer 458 and the sheet conductor 434 is dependent on the conductivity required of the SIC layer 458 and the sheet conductor 434 interface and other system considerations. More overlap assists current distribution and reduces electric resistance.

Sealing material 436 may be disposed proximate to an edge 450 of the fuel cell tube 430 between the sheet conductor 434 and the substrate 420 or other fuel cell component such as, e.g., the electrolyte 410 or the PAB 418, to include the CCC 406 and SIC layer 458. The sealing material 436 may comprise at least one material selected from the group comprising, glass, glass-ceramic, stabilized zirconia, alumina, La₂Zr₂O₇ pyrochlore and SrZrO₃.

The sheet conductor 434 and sealing material 436 may continue from the top surface 452 to the bottom surface (not shown) of tube 430. With this design, the sealing material 436 functions to seal the edges (e.g., 548 (not shown) and 450), thereby preventing fuel flowing from the channel 442 through the porous substrate 420 or oxidant leaking toward the channels 442. Additionally, sheet conductor 434 will provide an electrical path from a location on one of the major surfaces 452 of tube 430 to a location on another major surface (e.g. 454 (not shown)). The first location may be from a fuel cell 440 on the top surface 452 to a fuel cell 440 (not shown) on the bottom surface (not shown), although both locations need not be on a fuel cell or an electrochemically active fuel cell. For example, the SIC layer 458 may be extended beyond the cell 440 along the surface 452 of tube 430. The sheet conductor 434 may then be electrically coupled to the SIC layer 458 such that the sheet conductor 434 does not overlap the cell 440 in the y direction; such an overlap is shown in FIGS. 4A and 4B. This design enables the electrical coupling of fuel cells 440 on different surfaces of the same tube 430 to one another, and provides an electrical pathway from one side of a fuel cell tube to another. This design eliminates the need for SIC wires to provide this intra-tube fuel cell electrical coupling.

Sheet conductors 434 may comprise a conductive ceramic or cermet and may be applied to the fuel cell tube 430 using an ink-paste dispensing method. In some embodiments the sheet conductor 434 may be applied through a conductive adhesive tape. The conductive ceramic may be LSM, PSM, LNF, LSF, LSCF, LSC etc. The ceramic component of the cermet may comprise conductive ceramic, such as LSM, PSM, LNF, LSF, LSCF, LSC etc, inert ceramic, such as YSZ, CSZ, ScSZ, Al2O3, La2Zr2O7, etc, or glass-ceramic in a 5 to 70 v % of the cermet and may comprise an alkaline aluminosilicate. In some embodiments glass-ceramic may comprise 20 to 60 v % of the cermet. In some embodiments, glass-ceramic may comprise 55 v % of the cermet. The metal component of the cermet may comprise a precious metal such as, e.g., Pd, Ag, Pt, and Au. In some embodiments the metal component cermet may comprise binary or ternary alloys of a precious metal. In some embodiments, the metal component may comprise a noble metal. In some embodiments, the metal component may comprise a nickel metal. The sheet conductor 434 may comprise nickel cermet, such as xNiO−(100−x)YSZ, wherein, 40<x<80 in weight percent, or xNiO−zTiO2−(100−x−z)YSZ, where in 40<x<80, 0<z<40 in weight percent. Preferably the volume fraction of Ni metal is 30 v % or higher after reduction.

The sheet conductor can be applied by several means including but not limited to techniques for ink deposition and adhesive tapes. After firing, the thickness of the sheet conductor may be around 20 to 100 micrometers thick. Depending on the conductivity of the cermet, the sheet conductor thickness can be in the range of 10 to 200 micrometers. The conductivity can be in the range of 500 to 10,000 S/cm, preferred to be higher than 4,000 S/cm.

The SIC layer 458 may also be known as an SIC bond layer. The SIC bond layer may comprise a conductive material. SIC layer 458 may have a thickness from 5 to 50 mircometers and a conductivity of 2,000 to 6,000 S/cm. The SIC bond layer 458 may help current distribution across the width of a fuel cell 440 and may be optimized for this function. This layer 458 and optimization may be required because the CCC 406, designed to balance conductivity and porosity to allow oxidant to flow to the cathode 408, may have a lower conductivity in the range of 20-50 S/cm. The SIC layer 458 may be dense or porous.

FIGS. 4A and 4B depict a SIC layer 458 that is at least partially overlapping the fuel cell 440 in the y direction. The SIC layer 458 functions to provide an electrical pathway between the CCC 406 and the sheet conductor 434.

In accordance with some embodiments, the fuel cell system 400A and 400B may not comprise SIC layer 458. Rather, the sheet conductor 434 may directly contact CCC layer 406. One of ordinary skill will recognize that the design tradeoffs and necessity for a SIC layer 458 is related to the particular composition and electrical conductivity and other characteristics of the CCC layer 406 and other system requirements.

In the embodiment illustrated in FIG. 4B, the fuel cell system 400B may comprise a plurality of components such as those described above for FIG. 4A. Additionally, the fuel cell system 400B may comprise a protection material 468 disposed on an outer surface of the sheet conductor 434, wherein the outer surface is that surface facing away from the substrate 420 of fuel cell tube 430. This protection material 468 may comprise YSZ, ScSZ, CSZ, La₂Zr₂O₇, Al₂O₃, glass-ceramic and other materials disclosed for sealing material 436. This protection layer may function to prevent or reduce the loss of material from the sheet conductor 434, especially precious metal and interaction between the sheet conductor 434 and the oxidant.

In accordance with some embodiments of the present disclosure, a fuel cell system 500 having a fuel cell tube 530 is illustrated in FIG. 5. The fuel cell tube 530 may comprise a CCC 506, cathode 508, electrolyte 510, anode 512, ACC 514, PAB 518, SIC wire 504, conductive bonding paste 528, fuel cell 540, channel 542, surface 552, SIC layer 558 and porous substrate 520 and additional components not shown such as a primary interconnect, chemical barrier, dense barrier, and ceramic seal. Each of these components may be as described in the above embodiments. The fuel cell tube 530 may further comprise a sheet conductor 534, which may be as described above, and a sealing material 536 which may be comprised of the materials described above. Sealing material 536 may be disposed proximate to an edge 550 of the fuel cell tube 530, with the sheet conductor 534 disposed between the sealing material 536 and the substrate 520 or other components such as, e.g., the electrolyte 510 or PAB 518. In some embodiments, sheet conductor 534 may comprise a NiO. The NiO may be reduced to Ni under low pO2 and become conductive.

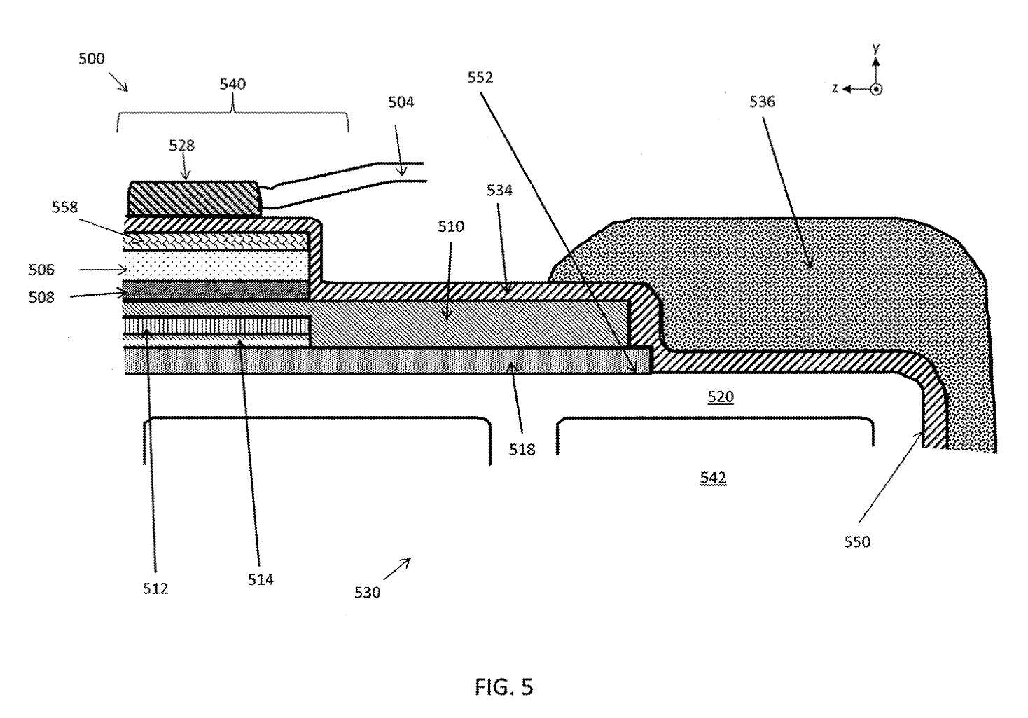

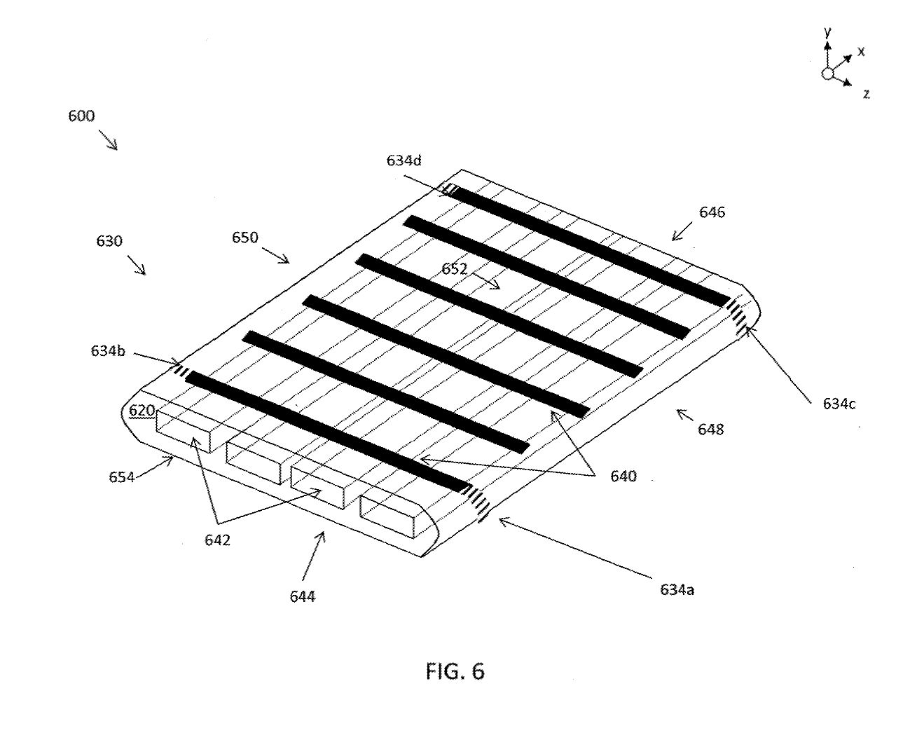

In accordance with some embodiments of the present disclosure, a perspective view of fuel cell system 600 having a fuel cell tube 630 is provided in FIG. 6. The tube 630 may comprise a plurality of fuel cells 640 disposed on a substrate 620 having internal passages 642 therein. The tube may have a first end 644 and a second end 646, and a first edge 648 and second edge 650. The tube 630 may further comprise sheet conductors 634a-d. As shown in FIG. 6, a pair of sheet conductors, e.g., 634a and 634b, may be disposed near an end 644 of the tube at edges 648 and 650, respectively. Similarly, another pair of sheet conductors, e.g. 634c and 634d may be disposed proximate to the other end 646 of tube 630 near edges 648 and 650, respectively. In this manner, the plurality of fuel cells 640 on surface 652 may be electrically coupled to a plurality of fuel cells 640 (not shown) on the surface 654 of tube 630. In some embodiments, the other surface 654 may not have any fuel cells disposed thereon, and the sheet conductors 634a-d may function to provide an electrical pathway from one surface 652 to the other surface 654 without the use of SIC wires.

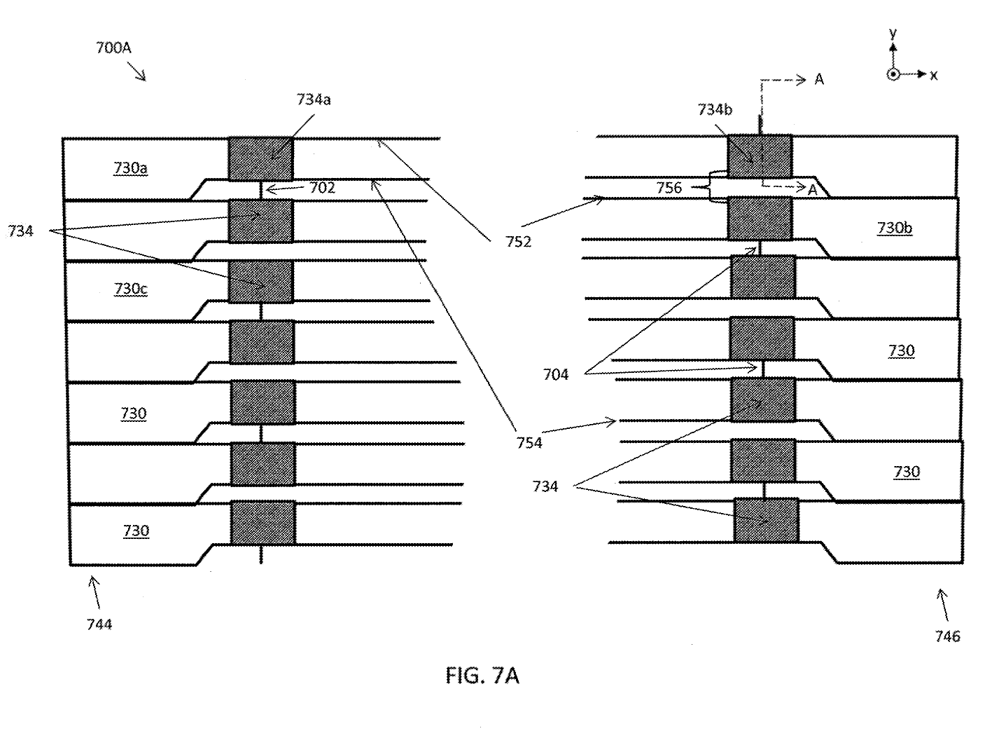

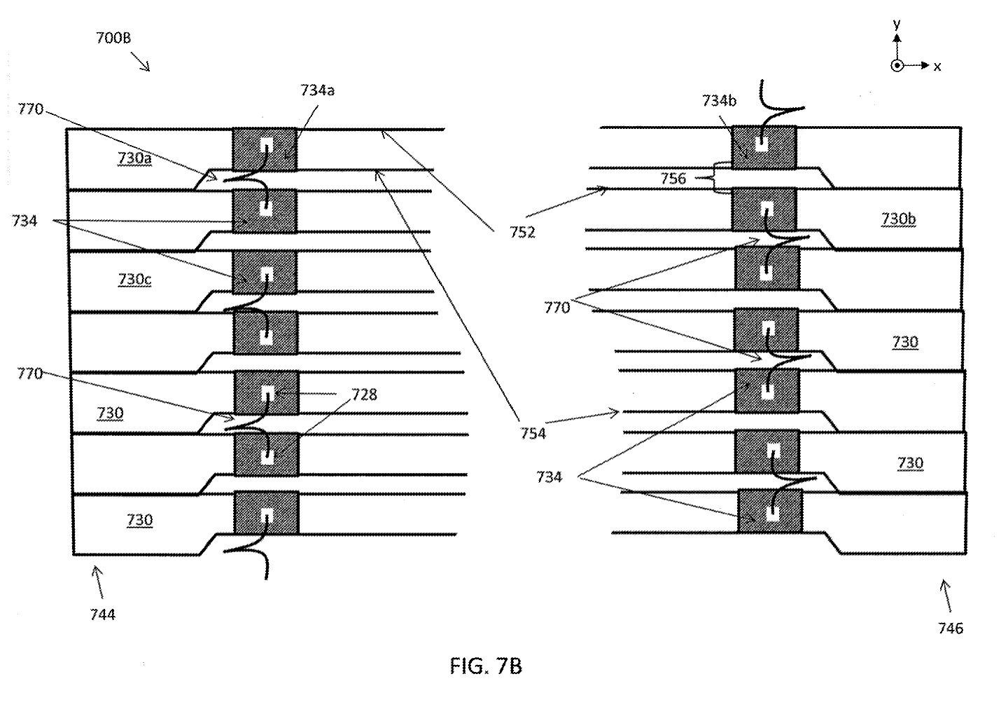

In accordance with some embodiments of the present disclosure, a fuel cell system 700A bundle is illustrated in FIG. 7A. The system 700A may comprise a plurality of fuel cell tubes 730 and at least one secondary interconnect 702. The tubes 730 may be stacked upon one another. The fuel cell system 700A having tubes 730 may be of a similar design to fuel cell systems and comprise components similar to those described for the fuel cell systems described above.

Each of the tubes 730 may have a first end 744 and second end 746, which may be proximate to the left and right edges of FIG. 7A, respectively, and a first and second surface 752 and 754, respectively, which extend continuously between the first and second ends 744 and 746. These first and second surfaces 752 and 754 and may be comprised of the porous, ceramic substrate and are the surfaces on which a plurality fuel cells (not shown) may be deposited, although in some embodiments fuel cells may be deposited on only one of the first and second surfaces for at least one of the plurality of tubes 730. In some embodiments, the plurality of fuel cells on any single surface are electrically coupled to the other fuel cells on the same surface in series by a primary interconnect (not shown). The surfaces of the tubes 730 may be generally planar, opposing major surfaces. In some embodiments, there may be a pair of planar surfaces, although in some embodiments there may be more than two surfaces for tube 730. In some embodiments, tubes 730 may be comprised of a single major surface which may not be planar, such as, e.g., an outer surface of a circular or oval tube.

The fuel cells located on the first surface 752 of a tube 730 may be electrically coupled to the fuel cells located on the second surface 754 of the same tube 730. However, wires are not used to couple the fuel cells on the same tubes 730. Rather, sheet conductor 734, is electrically coupled to the anode, ACC, cathode or CCC or conductor (e.g. conductor 326) of one or more fuel cells on a tube 730. For example, the sheet conductor 734 may electrically couple to the fuel cells closest to end 744 on both the top and bottom surfaces of the 752 and 754 on the same tube 730a. Similarly, a sheet conductor 734 may electrically couple to the fuel cells closest to end 746 on both the top and bottom surfaces of the 752 and 754 on the same tube 730a. The sheet conductor 734 will provide an electrical path from a location on one of the surfaces of a tube 730a to a location on the other (or another, in embodiments in which there are more than two planar surfaces) surface of the same tube 730a. As will be appreciated by one of skill in the art, there are a myriad of electrical connections which may be formed between fuel cells on a single tube 730 using one or more sheet conductors 734. In some embodiments, the first and second sheet conductors 734 (e.g. 734a and 734b) are arranged such that the fuel cells disposed on the first surface 752 of a tube 730a are electrically coupled in parallel with the fuel cells disposed on the second surface 754. This may be achieved, e.g., by connecting a first sheet conductor 734a to the cathode, CCC, SIC layer or equivalent component of the fuel cells on both the first and second surfaces proximate the end 744 of the tube 730a and connecting the second sheet conduct 734b to the anode, ACC, SIC layer or equivalent component (such as a conductor of an electrochemically inactive cell as shown in FIG. 3) proximate the another end 746 of tube 730a.

In some embodiments, a first tube 730a may be positioned with one of its major surfaces 754 being spaced from and parallel to a major surface 752 of a second, adjacent fuel cell tube 730b. In some embodiments, a third fuel cell tube 730c may be present wherein the third fuel cell tube 730c is positioned with a major surface 752 of that tube being spaced from and parallel to a major surface 754 of the second fuel cell tube 730b.

The fuel cell tubes 730 are electrically coupled to one another using SIC wire 702. As can be seen in FIG. 7A, the SIC 702 may provide an electrical path between a first tube 730a and a second tube 730b in the bundle 700 by electrically contacting the first sheet conductor 734a of the first tube 730 proximate the first end 744 of the first tube 730a and the first sheet conductor 734 of the second tube 730b proximate the first end 744 of the second tube 730b. In some embodiments, the second fuel cell tube 730b may be electrically coupled to a third fuel cell tube 730c by a second secondary interconnect 704. This second secondary interconnect 704 may be electrically coupled to the second sheet conductor 734 of the second tube 730b proximate to the second end 746 of the second tube 730b and to a sheet conductor 734 of the third tube 730c proximate an end 746 of the third tube 730c. This arrangement provides for alternating the ends on which a fuel cell tube 730 is connected to adjacent tubes, thereby maximizing the distance between tubes 730a and 730b on the end 746 where no electrical connection between tubes is needed. Maximizing the distance, or providing a larger gap 756, between tubes 730 by eliminating SIC wires, when compared to previous designs, provides for a more robust system in which the SIC gap is controlled by the designed tube gap and is less dependent on installation and operational factors. This alternating SIC wire 702/704 design reduces the risk of arcing or short circuits between the fuel cells on tubes 730 where no electrical connection is needed while allowing a smaller gap between adjacent tubes because SIC wire movement is less of a concern during manufacturing, handling, installation, and testing when compared to the old designs. The elimination of the extra SIC wires provides for a design in which system robustness is less dependent on the system operators and manufacturers.

Depending on the arrangement of the SIC(s) 702 and 704 that connect tubes 730 and the sheet conductor(s) 734 electrically contacting one or more fuel cells on tubes 730, the tubes 730 may be electrically arranged in series or parallel. For example, the sheet conductor 734 proximate the first end 744 of uppermost tube 730a in FIG. 7A may be electrically coupled to the anode of the fuel cells(s) proximate this end 744 of the tube. The sheet conductor 734 proximate the first end 744 of the second uppermost tube 730b may be electrically coupled to the cathode of the fuel cell(s) proximate this end 744 of the second uppermost tube 730b. SIC 702 electrically contacts these two sheet conductors 734 and therefore electrically couples the uppermost tube 730a in series with the second uppermost tube 730b. As can be appreciated, alternating the location and component to which these electrically connections are made may allow tubes 730 to be connected in parallel, series, or in other electrical arrangements with other tubes 730.

In accordance with some embodiments of the present disclosure, a fuel cell system 700B bundle is illustrated in FIG. 7B. The fuel cell system 700B may be substantially similar to fuel cell system 700A and comprise like components as described above. However, the system 700B may comprise a difference SIC wire design. For example, rather than connecting SIC wires 702 and 704 in a manner that is parallel to the surface 752 and 754, the SIC wires 770 are electrically coupled to the sheet conductors 734 at the edge of fuel cell tubes 730 (e.g., edges 648 and 650 shown in FIG. 6). A conductive paste 728, such as the conductive/binding pastes described above, may be applied to the edge of the tubes 730 and bond the SIC wires 770 to the tubes 730. While the surface on to which the SIC wires 770 are bonded may be smaller at the tube 730 edge than a surface which parallels the first or second surface, bonding the wires on the tube 730 edge may provide for easier construction and maintenance. One wire 770 is connected to a tube 730 at its edge and then is bonded, e.g., sport welded, to another wire 770 on an adjacent tube. The wires 770 may be bonded in an alternating fashion as shown in FIG. 7B and may provide for the same, flexible manner of electrical connections as described above.

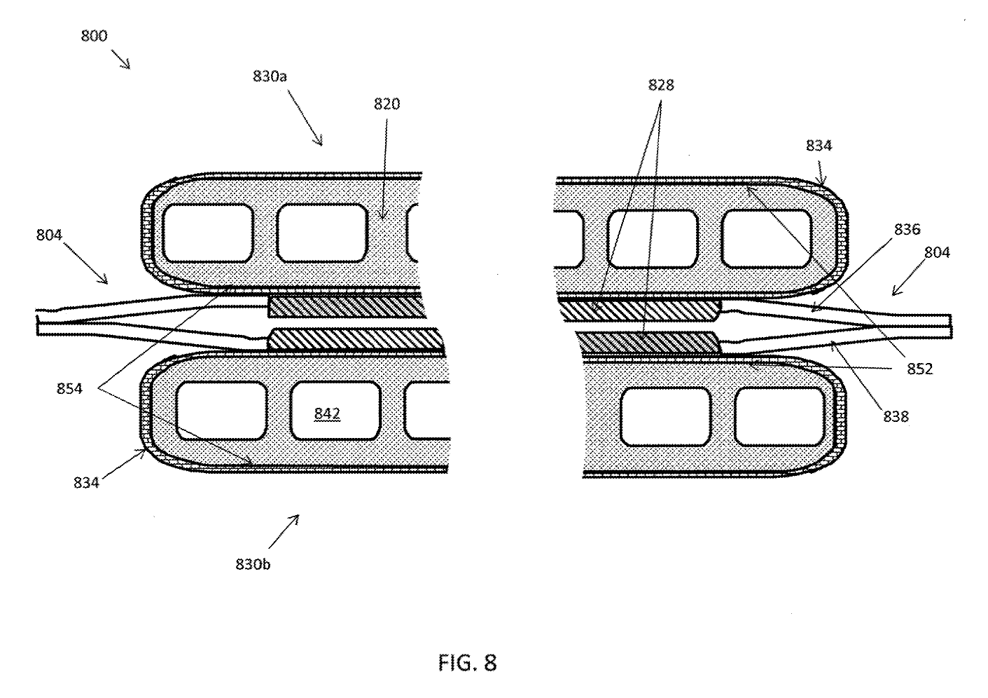

In accordance with some embodiments of the present disclosure, a cross section of bundle 800 of fuel cell tubes 830 is shown in FIG. 8. The cross section may be cross section A-A as shown in FIG. 7A. The fuel cell tubes 830 may each be similar to those as described above and may have the same components. The fuel cell tubes 830 may have one or more sheet conductors 834 that provide an electrical pathway from a location on one major surface 852 to another major surface 854, which may be from one fuel cell (not shown) to another. The tubes may each comprise a ceramic substrate 820 having internal passages 842 therein. SIC wires 804 are electrically coupled to fuel cells on tube 830, and then are bonded, as described above, to provide an electrical pathway from the cells on one tube 830a to the cells on another tube 830b.

SIC 804 may comprise a first wire 836 electrically coupled to a sheet conductor 834, which may be a first sheet conductor, of the first (here upper) tube 830a. Wire 836 may be electrically contacting this sheet conductor 834. SIC 804 further comprises a second wire 838 electrically coupled to the sheet conductor 834, which may be a first sheet conductor of a second (here lower) tube 830b. Wire 838 may be in electrical contact with the lower sheet conductor 834. Wires 836 and 838 are bonded together in order to maintain the electrical coupling between the fuel cells of the upper tube 830 and the fuel cells of the lower tube 830. Wires 836 and 838 may be spot welded or bonded together by some other bonding. A bonding paste 828 may be used as described above.

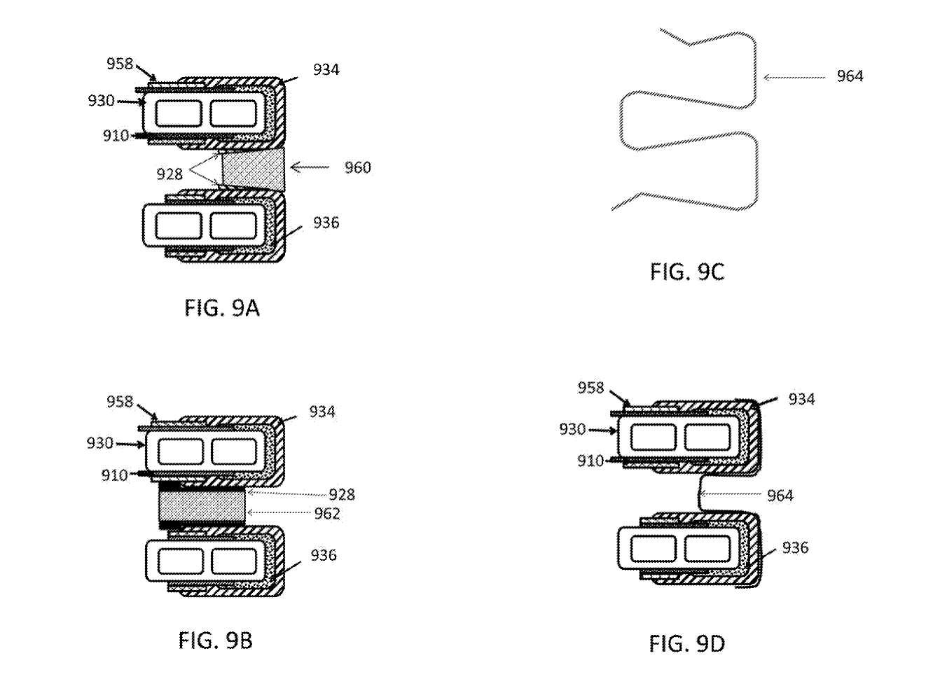

In accordance with some embodiments of the present disclosure, designs for interconnecting adjacent fuel cell tubes 930 are illustrated in FIGS. 9A-9D. The illustrations are cross sectional, end views of a tube cell tube 930 in the proximity of cross section A-A shown in FIG. 7A. While each tube 930 is illustrated comprising a SIC layer 958 (in some embodiments a CCC), electrolyte 910, sheet conductor 934, and sealing material 936, the tubes 930 may comprise further components and have the alternate designs as described with respect the fuel cell tubes described above. FIGS. 9A and 9B further illustrate a bonding paste 928 that may comprise the same materials as described for the bonding/conductive pastes as described above. Only selected components of the fuel cell system are shown or described to illustrate the features of the SIC designs.

In accordance with some embodiments, as illustrated in FIG. 9A and FIG. 9B, ceramic member, which may be a wedge 960 or shim 962, may be inserted near an edge of the tube 930 such that the wedge 960 or shim 962 is in contact with the sheet conductors 934 of two adjacent tubes 930. The wedge 960 may be a conductive ceramic and may comprise LSM, LNF, some other ceramic, or some combination thereof. Shim 962 may comprise LSM, LNF, PSM, LSF, LSCF, LSC etc. Further, a conductive bonding paste 928 may be used between all or a portion of interface between the wedge 960 and the sheet conductor 934. As illustrated in FIG. 9B, the bonding paste 928 may further be applied to the SIC 958 in addition to the sheet conductor 934, depending on the length of the wedge 960 or shim 962. In embodiments wherein the sealing material 936 overlays the sheet conductor 934 in part (not shown), the wedge 960 or shim 962 may have sufficient length such that it electrically engages the sheet conductor 934 or SIC 958 at a location away from the tube 930 edge. Wedge 960 or shim 962 may be a resilient design such that an interference type fit maintains the wedge 960 in position. Further, the bonding paste 928 may assist in holding the wedge 960 or shim 962 in position.

In accordance with some embodiments of the present disclosure, a resilient member 964 may be provided as illustrated in FIGS. 9C and 9D. The resilient member 964 may be frictionally fit over the sheet conductors 934 of adjacent tubes 930 such that member 964 is in contact with both simultaneously. The frictional fit may hold member 964 in position relative to the tubes 930. In some embodiments, a paste may be applied between the member 964 and the sheet conductor 934 (or sealing material 936 in embodiments in which sealing material 936 overlays the sheet conductor 934) that reduces the friction during installation, provides a bonding to hold the member 964 in position, provides a better electrical contact between the member 964 and the sheet conductors 934 or some combination of the foregoing. The member 964 may be a described as a flexible and resilient, and may comprise a metal such as, e.g., Crofer 22H, Inconel, FeCr alloy, stainless steel, or some combination of the foregoing.

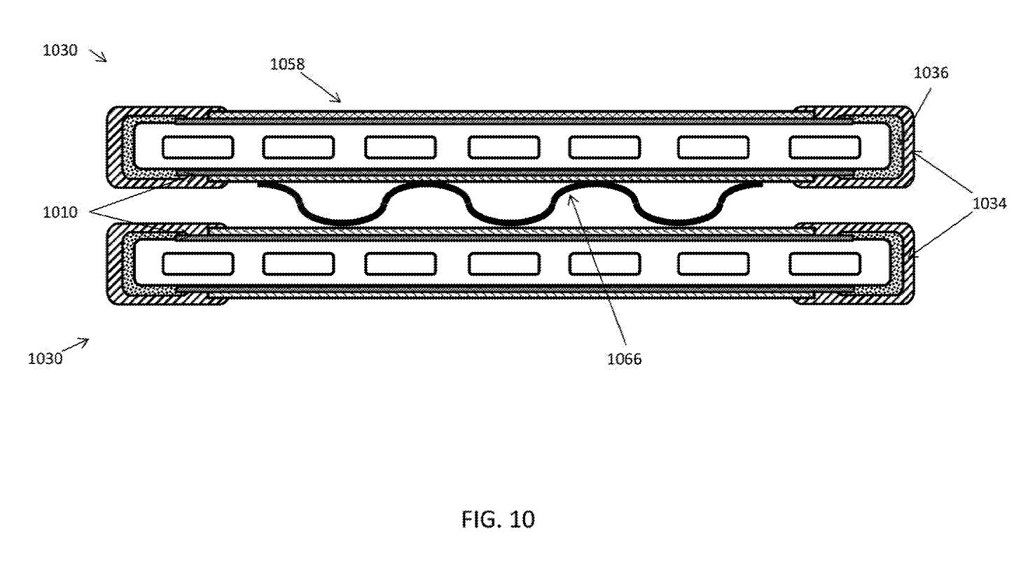

In accordance with some embodiments of the present disclosure, a corrugated member 1066 providing an electrical path way between adjacent tubes 1030 is provided in FIG. 10. The tubes 1030 may comprise the components described for the fuel cell tubes in the above embodiments, e.g., electrolyte 1010, conductor 1034, sealing material 1036, SIC layer 1058 among others. The cross-section, tube-end view of the tubes 1030 may be understood as being located near a position on the tube 1030 near to that show at the cross section A-A in FIG. 7A. The member 1066 may be resilient and flexible and designed such that the placement of one tube 1030 adjacent to another causes the member 1066 to be compressed, thereby increasing the area of contact between the member 1066 and the SIC layer 958 (or CCC), sheet conductor 1034, or both. Additionally, the member 1066 may be secured, for example, by a bonding paste, such that the member 1066 is attached to one tube 1030. This arrangement may facilitate the assembly of a bundle of fuel cell tubes 1030. In some embodiments, the member 1066 may be installed by sliding the member 1066 between two tubes 1030 that are already adjacent to one another. The resiliency of member 1066 may provide a force that frictionally maintains the member 1066 in position during operations. In some embodiments, one or more pastes may be used to aid the sliding of the member 1066 between the tubes, to adhere the member 1066 to the SIC layer 958, sheet conductor 1034, or both, to increase the electrical coupling between the member 1066 and the fuel cells on tubes 1030, or some combination of the foregoing. In some embodiments, the member 1066 may be designed to have a generally sinusoidal wave shape. In some embodiments, the wave may have a more square-wave like shape to increase the contact area of the member 1066 and the SIC 958 (or CCC), sheet conductor 1034, or both. The member 1066 may be a conductive metal such as, e.g., Crofer 22H, Inconel, FeCr alloy, stainless steel, or some combination of the foregoing.

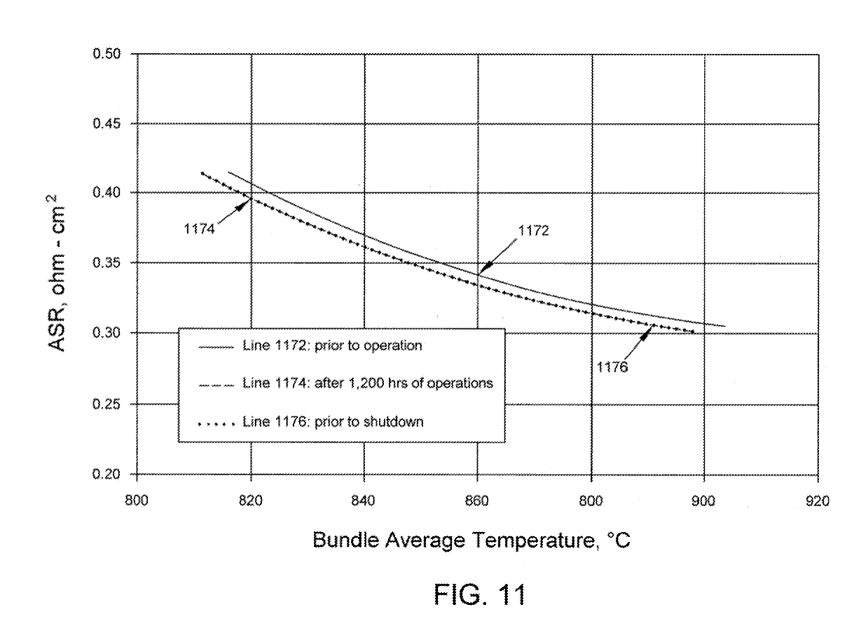

A test of a fuel cell system such as that shown in FIG. 4A was performed showing no significant degradation in fuel cell performance. One plot showing these results is provided for in FIG. 11. This figure shows the area specific resistance (ASR) of a fuel cell system measured at different temperatures at three different times during the test: prior to operating the fuel cell system (Line 1172); after operating the fuel cell for 1,200 hours (Line 1174); and, 3 cycles prior to conclusion of the test (Line 1176). As can be seen, the fuel cell system ASR at all three points during the test showing substantially similar values and substantially similar changes with respect to temperature. The ASR at each temperature after 1,200 hours (Line 1174) is essentially identical to the ASR after XX thermal cycles (Line 1176), and both lines have a minimal reduction in ASR from that at the beginning of the test (Line 1172).

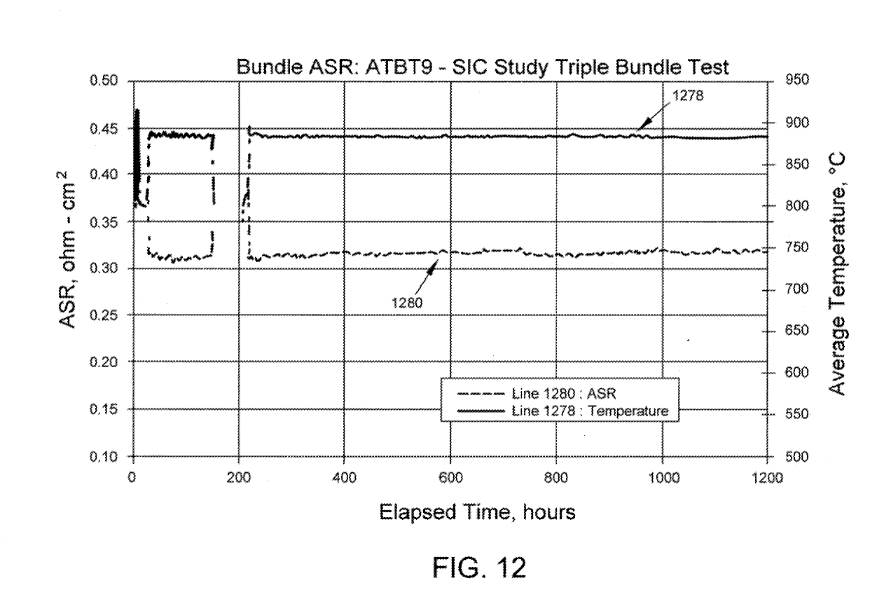

FIG. 12 is a plot of the fuel cell system ASR (Line 1278) and temperature (Line 1280) over time. Over 1,200 hours of operation, the fuel cell system ASR degraded at a rate of 0.0075 ohm-cm² per 1,000 hrs. The lack of any significant degradation demonstrates that the fuel cell embodiments described above provide for a more robust fuel cell system that is less susceptible to issues experienced with prior SIC wire designs.

Various embodiments of the disclosure have been described. These and other embodiments are within the scope of the following claims.

We claim:

1. A fuel cell system comprising:
a plurality of stacked fuel cell tubes, each tube comprising:
a substrate having a pair of opposing major surfaces and defining a plurality of parallel channels between said major surfaces extending from a first end to a second end of said tube;
a plurality of fuel cells disposed on one of said major surfaces, said fuel cells being electrically coupled in series;
a first sheet conductor proximate the first end of said tube, said first sheet conductor providing an electrical path from a location on one of said major surfaces to a location on the other of said major surfaces; and
a second sheet conductor proximate the second end of said tube, said second sheet conductor providing an electrical path from a location on one of said major surfaces to a location on the other of said major surfaces; and
a secondary interconnect electrically coupled to the first sheet conductor on adjacent fuel cell tubes thereby electrically coupling the fuel cells disposed on one fuel cell tube to the fuel cells disposed on an adjacent fuel cell tube.

2. The fuel cell system of claim 1 wherein one or more sheet conductors comprise a conductive ink trace.

3. The fuel cell system of claim 1 wherein said secondary interconnect comprises a ceramic member in contact with the first sheet conductors of adjacent fuel cell tubes.

4. The fuel cell system of claim 3 wherein said ceramic member comprises LSM or LNF.

5. The fuel cell system of claim 1 wherein said secondary interconnect comprises a resilient member having frictionally fit over each of the first sheet conductors of adjacent fuel cell tubes.

6. The fuel cell system of claim 5 wherein said resilient member comprises Crofer 22H, Inconel, FeCr alloy, or stainless steel.

7. The fuel cell system of claim 1 wherein said secondary interconnect comprises a corrugated member positioned between adjacent fuel cell tubes.

8. The fuel cell system of claim 7 wherein said corrugated member comprises Crofer 22H, Inconel, FeCr alloy, or stainless steel.
